(19) United States
(12) Patent Application Publication
(10) Pub. No.: US 2005/0227842 A1
(43) Pub. Date: Oct. 13, 2005

(54) Method and device for conveying and erecting boxes

(75) Inventor: Renato Brintazzoli, Bologna (IT)

Correspondence Address: WILLIAM J. SAPONE;COLEMAN SUDOL SAPONE P.C., 714 COLORADO AVENUE, BRIDGE PORT, CT, 06605, US

(73) Assignee: Marchesini Group S.p.A., Bologna (IT)

(21) Appl. No.: 11/100,835

(22) Filed: Apr. 7, 2005

(30) Foreign Application Priority Data
Apr. 9, 2004 (IT) BO 2004A 000209

(51) Int. Cl. B31B 11/02

(52) U.S. Cl. 493/71

(57) ABSTRACT

A method and a device for conveying and erecting boxes made of cardboard or the like, provide for withdrawing each box in an initial flattened configuration, in which the box is arranged in two overlapped layers, by means of at least one picking up member for engaging the box on a wall, and moving the box first through an erecting station, in which the layers are moved far from each other, to give to the box a final, erected configuration with two open ends, and then through at least one closing station, in which one of the open ends are closed.

### BACKGROUND OF THE INVENTION

The present invention relates to a method for conveying and erecting of boxes.

### BRIEF DESCRIPTION OF THE PRIOR ART

There are known so-called boxing machines among the machines for packaging products, in particular cosmetic products.

The boxing machine includes an inlet magazine, for housing a pile of tubular boxes, each of which has a plurality of walls defined by pre-weakened folding lines and is in an initial flat blank configuration, in which the box is arranged with two overlapped layers, each of which is defined by two adjacent walls of the box.

The boxing machine includes also a device for withdrawing and transferring the boxes, which has a picking up member, which picks up the boxes, one by one, from the inlet magazine, engages each box on a relative wall, and feeds the boxes, one by one, to a pocket filling conveyor.

The filling conveyor includes two chains, which move in respective planes, substantially parallel to each other, and which have a plurality of pushing elements, extending between the chains, uniformly distributed along the chains, and moved by the chains along a prefixed endless path.

Each pushing element separates two adjacent pockets of the filling conveyor.

Each of the pockets receives and keeps a relative box and its length, measured parallel to the path, approximates by excess to the dimension of a box, likewise measured parallel to the path.

Two lateral guides, connected to the filling conveyor, extend on the opposite sides of the pushing elements to define a boxes feeding channel. A lower guide supports the lower part of the boxes.

Each box reaches, inside a relative pocket, a final erected configuration, in which the box has a parallelogram section and has also a first end open, which is closed immediately, and a second end open, which is first left open, in order to allow the feeding of at least one article into the box.

The known boxing machines of the above described type present some disadvantages deriving mainly from the fact that each box is kept inside the relative pocket by the relative pushing elements, which are suitable for assuring a precise positioning of the box inside the pocket.

Consequently, the effective position of the box inside the relative pocket can be varied with respect to the theoretical position during the erecting of the box from its initial flattened configuration to its final erected configuration, which makes it difficult to close the first open end, as well as during the closing of the first open end, which makes it difficult to feed the article into the box.

Moreover, the known boxing machines of the above described type present another disadvantage deriving from the fact that the feeding of the boxes along the lateral guides and along the lower guide can damage the boxes.

### SUMMARY OF THE INVENTION

The object of the present invention is to propose a method for conveying and erecting boxes, which does not present the above mentioned disadvantages and which is simple and cheap to produce.

According to a first aspect, a method is proposed by the present invention, in accordance to claim 1, for conveying and erecting boxes, each box being made of cardboard or the like and including a plurality of walls defined by pre-weakened folding lines, and being erected beginning from an initial flat configuration, in which the box is arranged in two overlapped layers with each layer defined by at least one wall of the box;
the method including:
withdrawing each box in its initial flat configuration at a loading station, performed by at least one picking up member engaging with said wall;
moving said layers far from each other, so as to give to the box a final, erected configuration, in which the box has a parallelogram section and two ends open; and
closing a first end of said open ends;
in which method erecting the box from the initial, flat configuration to the final, erected configuration and closing said first open end are performed with the box kept engaged by the picking up member.

According to a second aspect, the present invention relates to a device for conveying and erecting boxes, in accordance to claim 9, each of the boxes being made of cardboard or the like, and including a plurality of walls defined by pre-weakened folding lines, and which box is erected beginning from an initial, flat configuration, in which the box is arranged in two overlapped layers, with each layer of said layers being defined by at least one wall of the box;
the device including a loading station for withdrawing at least one box in initial, flat configuration;
an erecting station, in which the box is given a final, erected configuration, in which the box has a parallelogram section and two open ends;
at least one closing station for closing a first end of said open ends;
at least one picking up member, which engages one wall of the box to withdraw the latter at the loading station; and
conveying means for moving the picking up member through the loading station, the erecting station and the closing station.

### BRIEF DESCRIPTION OF THE DRAWINGS

Now the present invention will be described with reference to the enclosed drawings, showing a non limiting embodiment, in which:

FIG. 1 is a perspective, schematic view, with some parts removed for sake of clarity, of a preferred embodiment of the boxing machine proposed by the present invention;

FIG. 2 is a perspective, schematic view, with some parts removed for sake of clarity, of a first detail of FIG. 1;

FIG. 3 is a lateral, schematic view, with some parts in section and some parts removed for sake of clarity, of a second particular of FIG. 1; and

FIGS. 4 to 6 are perspective and schematic views of the boxing machine of FIG. 1, in three different working positions.

### DESCRIPTION OF THE PREFERRED EMBODIMENTS

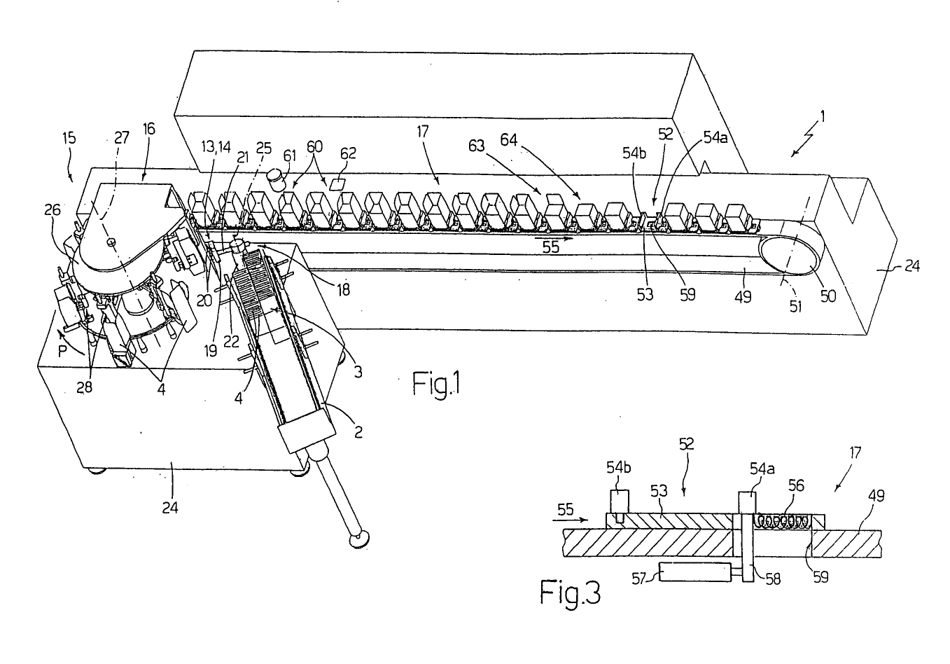

With reference to FIGS. 1 and 5, the reference numeral 1 indicates a boxing machine as a whole, which includes a magazine 2, receiving a pile 3 of tubular boxes 4.

Each of the tubular boxes 4 has, in a final, erected configuration, a parallelogram section defined by a pair of parallel walls 5, a pair of parallel walls 6, perpendicular to the walls 5, and by two open ends 7, each of which is defined, in this case, by two wings 8 connected to the walls 5 and by a flap 9, connected to one of the walls 6.

Each wall 5, 6 is connected to each adjacent wall 6, 5 along a pre-weakened folding line 10 and, likewise, each wing 8 is connected to the relative wall 5 and each flap 9 is connected to the relative wall 6 by further pre-weakened folding lines 10.

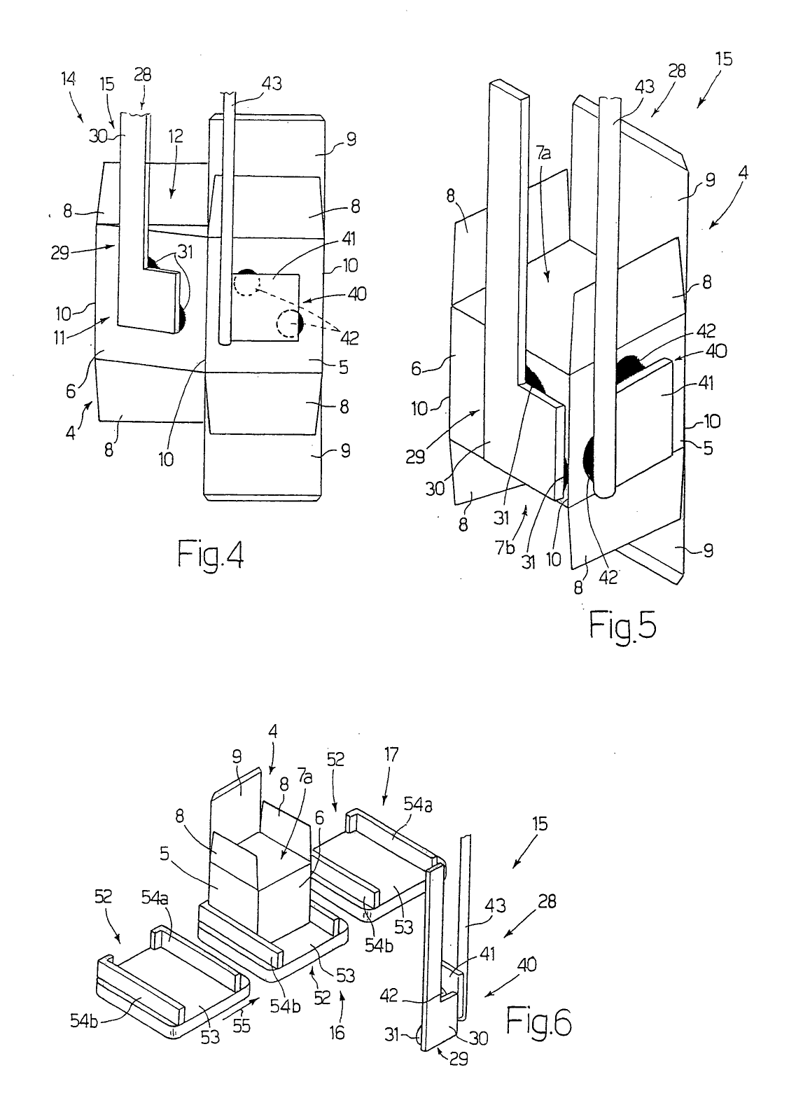

Each box 4 is arranged inside the magazine 2 in vertical position, with one of the ends 7 (from now on indicated with 7a) situated above the other end 7 (from now on indicated with 7b), and in an initial flat configuration, in which the walls 5, 6 are folded to form two overlapped layers 11, 12 (FIG. 4), substantially touching each other.

Each of the layers 11, 12 include two respective walls 5, 6.

According to what has been shown in FIG. 1, the machine 1 includes a withdrawing device 13 for withdrawing the boxes 4, one by one, from the magazine 2, in correspondence to a loading station 14.

A conveying and erecting device 15 receives, one after the other, the boxes 4 from the device 13 and feeds them along a path P, extending between the station 14 and a station 16, in which the boxes 4 are transferred to a pocket filling conveyor 17.

Then, the conveying and erecting device 15 erects the boxes 4 and closes the relative ends 7b during the boxes 4 feeding along the path P.

The device 13 includes a picking up member 18, which comprises a plate 19 equipped with a pair of suction cups 20, connected to a suction device of known type, not shown, and fastened to one end of a slide 21 coupled in known way to a turret 22.

The slide 21 can be oriented to perform straight movements with respect to the turret 22.

The turret 22 is coupled rotating to a stationary frame 24 of the machine 1, so as to rotate with respect to the frame 24 and due to the push of an operating device of known type, not shown, on a rotating axis 25, substantially vertical.

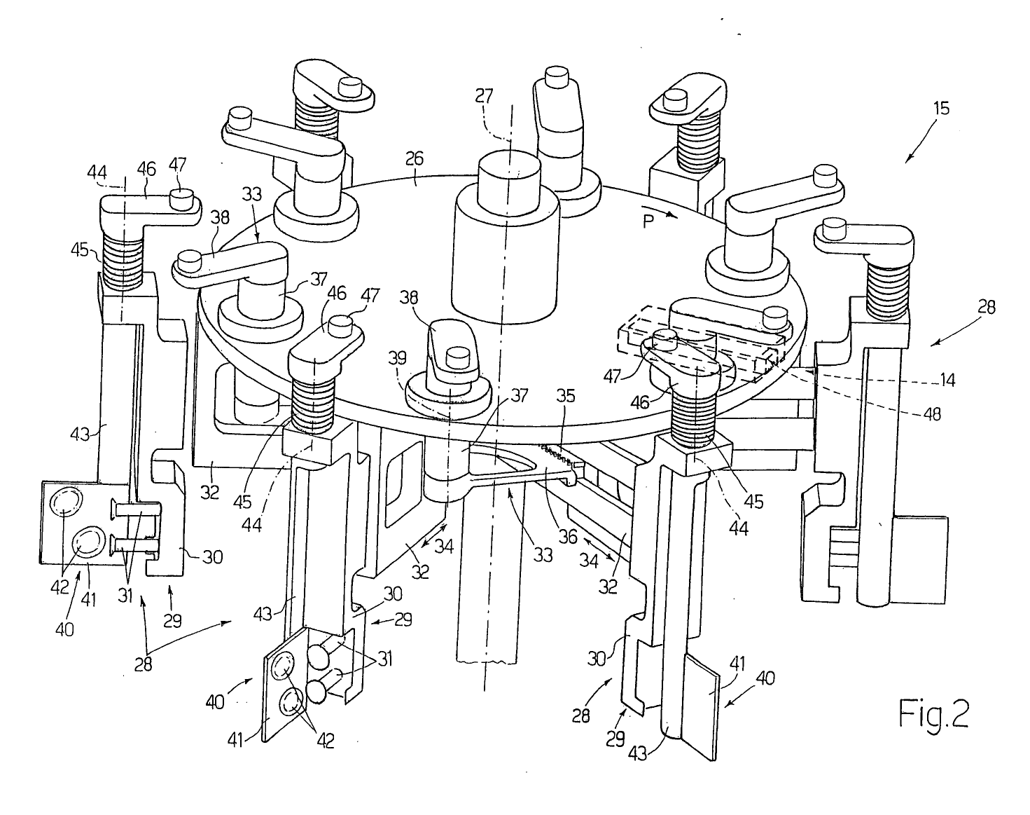

With reference to FIG. 2, the device 15 includes a drum 26, which is mounted rotating on the frame 24, and rotated in an intermittent way with respect to the frame 24 due to the push of a known and not shown motor, on an axis 27, parallel to the axis 25.

The drum 26 supports a plurality of conveying and erecting units 28 (in the present case six units 28), regularly distributed along the edge of the drum 26.

Each unit 28 includes a first picking up element 29, comprising a plate 30, which is substantially L-like and which is equipped with a pair of suction cups 31, connected to the suction device (not shown).

The plate 30 is fastened to an end of a slide 32 coupled in known way to the drum 26, in order to perform straight movements, due to the push of an actuator device 33, operated in correspondence to the stations 14 and 16 and in a relative radial direction 34, between a rear position (FIG. 2) and a withdrawn position (not shown).

The device 33 includes a rack 35, fastened to the slide 32 parallel to the direction 34, and coupled to a toothed section 36, which is integral with a shaft 37, mounted rotating through the drum 26, to oscillate with respect to the drum 26 and due to the push of a linkage 38, shown only partially in FIG. 2, on a rotating axis 39 parallel to the axis 27.

The unit 28 includes also a second picking up element 40, comprising a flat plate 41, which has a pair of suction cups 42 connected to the suction device (not shown), and which is fastened to one end of a shaft 43, mounted rotating through the plate 30, to rotate with respect to the plate 30, on an axis 44, whose fulcrum is parallel to the axis 27.

A torsionally flexible helical spring 45, surrounding the shaft 43, normally keeps the flat plate 41 in an erecting working position (FIGS. 2 and 5), in which the suction cups 42 are arranged orthogonal to the suction cups 31.

The shaft 43 has an arm 46, which extends outward from the shaft 43 and supports a roller 47, coupled rotatingly with the arm 46 and engaging, at the station 14 and during the movement of the unit 28 between its rear and withdrawn positions, with a path 48, substantially straight, arranged at an angle different from zero with respect to the direction 34.

The orientation of the path 48 with respect to the direction 34 is such that:
during the movement of the unit 28 from its rear position to its withdrawn position, the shaft 43 is moved clockwise on the axis 44 in FIG. 2, and against the action of the spring 45, so as to arrange the plate 41 in an engaged working position (FIG. 4), in which the suction cups 42 are arranged substantially parallel to the suction cups 31, in order to receive a box 4 from the device 13; and
during the movement of the unit 28 from its withdrawn position to its rear position, the roller 47 cooperates with the spring 45, to move the shaft 43 counterclockwise on the axis 44 in FIG. 2 and to arrange the plate 41 again in its erecting working position.

With reference to FIGS. 1 and 3, the pockets filling conveyor 17 includes a belt 49, which moves in a vertical plane and which is wound endlessly on a pair of pulleys 50, mounted on the frame 24 to rotate with respect to the frame 24 on respective horizontal rotation axes 51, transversal to the axis 27.

One of the pulleys 50 is motorized in steps.

The conveyor 17 includes also a plurality of pockets 52, which are distributed uniformly along the belt 49 and are fed by the belt 49 through the station 16, each in step relation with a relative conveying and erecting unit 28.

Each pocket 52 has a variable width including a flat bottom wall 53 fastened to the belt 49, and a pair of lateral walls 54, which are mounted on the plate 53, orthogonal thereto.

The lateral walls 54 are substantially orthogonal to a direction 55 of pockets 52 feeding and are arranged one (later indicated with 54a) before the other (later indicated with 54b) in the direction 55.

The wall 54b is integral with the wall 53, while the wall 54a is coupled slidingly with the wall 53, so as to move with respect to the wall 54b in the direction 55, and it is normally kept, by a spring 56 interposed between the walls 53 and 54a, in a first working position, in which the distance between the walls 54a and 54b approximates by defect to the minimum width of a box 4 measured parallel to the path P.

The wall 54a is moved, by an actuator 57, against the action of the spring 56 from the first working position to a second working position, in which the distance between the walls 54a and 54b approximates by excess to the maximum width of a box 4 measured parallel to the path P.

The actuator 57 is mounted in the transferring station 16 and engages a control bar 58, which protrudes from the wall 54a and engages slidingly with a slot 59 made through the wall 53 and the belt 49.

Moreover, the actuator 57 moves between a raised position (FIG. 3), in which the bar 58 is operated and a lowered, rest position (not shown), in which the actuator 57 rests below the bar 58, in order to allow forward motion of the pocket 52 in the direction 55.

The operation of the machine 1 will be now described with reference to the enclosed figures, taking into consideration the conveying, erecting and filling of only one box 4, and beginning from a moment, in which the picking up member 18 is in a loading position, facing the magazine 2, and in which the conveying and erecting device 15 moves a conveying and erecting unit 28 toward the loading station 14.

The slide 21 is moved through the turret 22 to allow the suction cups 20 first to engage the layer 11 of the box 4 in question and then, to allow the picking up member 18 to withdraw the box 4 from the magazine 2.

The turret 22 is rotated around the axis 25 to move the member 18 to the transferring position, facing a conveying and erecting unit 28, which reaches its withdrawn position, when the device 15 dwells in the station 14, to allow the roller 47 to engage with the path 48 and to allow the picking up member 40 to reach its engaging working position (FIG. 4).

When the box 4 has been released by the suction cups 20 to the suction cups 31 and 42, the unit 28 is moved again to its rear position.

During the movement of the unit 28 from its withdrawn position to its rear position, the picking up member 40 moves with respect to the picking up member 29 to reach its erecting position and to move the layers 11, 12 away from each other, so as to give to the box 4 its final, erected configuration (FIG. 5).

At this point, the device 15 is operated again to move the unit 28 in question in steps along the path P, first through a first closing station (not shown), in which the wings 8 of the end 7b are closed, then through a marking station (not shown), in which a code is affixed to the flap 9 of the end 7b, and finally, through a second closing station (not shown), in which the flap 9 of the end 7b, and subsequently the end 7b, are closed.

Afterwards, the unit 28 is fed to the transferring station 16, in step relation with a pocket 52 of the pocket filling conveyor 17.

When in the station 16, the wall 54a is moved by the actuator 57 to its second working position, against the action of the spring 56, and the unit 28 moves again to its withdrawn position, to release the box 4 in its final erected configuration and with the end 7b closed, into the pocket 52 in question (FIG. 6).

According to FIG. 1, when the box 4 has been positioned inside the pocket 52, the actuator 57 is deactivated to allow the walls 54a and 54b to assume a position, in which the box 4 is tightened therebetween, the unit 28 is moved to its rear position to disengage the box 4, and the box 4 is fed by the conveyor 17, first through a succession of filling stations 60 of known type, to introduce, into the box 4, for example an article 61 and an information leaflet 62, then through a first closing station 63, in which the wings 8 of the end 7a are closed, and finally, through a second closing station 64, in which the flap 9 of the end 7a and then the end 7a, are closed.

The boxing machine 1 presents some advantages, deriving mainly from the fact that the boxes 4 are withdrawn from the magazine 2 by the suction cups 20 and then they are transferred by the suction cups 31 and 42, which keep the boxes 4 without releasing them during the steps of erecting, marking of the flaps 9 of the relative ends 7b, closing the ends 7b and of introducing into the relative pockets 52.

Moreover, the boxing machine 1 presents another advantage deriving from the fact that the variable width pockets 52 allow the operator to avoid modifying the pockets 52 in function of the size of the boxes 4, used each time.

Moreover, the conformation of the conveying and erecting units 28 and of the pockets 52 avoid scratches and/or damages of any type to the boxes 4.

Obviously, both the conveying and erecting device 15 and the pocket filling conveyor 17 can be installed in a boxing machine operated in a continuous way.

1. A method for conveying and erecting boxes, each box being made of cardboard or the like and including a plurality of walls defined by pre-weakened folding lines, and being erected beginning from an initial flat configuration, in which the box is arranged in two overlapped layers with each layer defined by at least one wall of the box;
the method including:
withdrawing each box in its initial flat configuration at a loading station, performed by at least one picking up member engaging with said wall;
moving said layers far from each other, so as to give to the box a final, erected configuration, in which the box has a parallelogram section and two ends open; and
closing a first end of said open ends;
in which method erecting the box from the initial, flat configuration to the final, erected configuration and closing said first open end are performed with the box kept engaged by the picking up member.

2. A method as claimed in claim 1, wherein the box, in its final, erected configuration and with said first end closed, is transferred by the picking up member to a pocket conveyor for filling the box at a transferring station.

3. A method as claimed in claim 2, wherein the box is moved in steps by the picking up member along a defined path, extending between the loading station and the transferring station.

4. A method as claimed in claim 2, wherein the box is moved by the picking up member through a marking station, in which a code is affixed to the box; the marking station being situated between the loading station and the transferring station.

5. A method as claimed in claim 1, wherein at said loading station, the box, in said initial, flat configuration, is withdrawn from a magazine by at least one picking up member and is transferred in the initial, flat configuration by the picking up member to the picking up member.

6. A method as claimed in claim 5, wherein the picking up member is moved between a loading position, in which the picking up member faces the magazine, and a transferring position, in which the picking up member faces the picking up member.

7. A method as claimed in claim 1, wherein the box is withdrawn in the loading station by two said separate picking up members, which engage with the box at the intermediate points of respective walls, and which move one with respect to the other to give to the box said final, erected configuration.

8. A method as claimed in claim 1, wherein each of said picking up members is a suction picking up member, including at least one suction cup.

9. A device for conveying and erecting boxes, each of the boxes being made of cardboard or the like, and including a plurality of walls defined by pre-weakened folding lines, and which box is erected beginning from an initial, flat configuration, in which the box is arranged in two overlapped layers, with each layer of said layers being defined by at least one wall of the box;
the device including a loading station for withdrawing at least one box in initial, flat configuration;
an erecting station, in which the box is given a final, erected configuration, in which the box has a parallelogram section and two open ends;
at least one closing station for closing a first end of said open ends;
at least one picking up member, which engages one wall of the box to withdraw the latter at the loading station; and
conveying means for moving the picking up member through the loading station, the erecting station and the closing station.

10. A device as claimed in claim 9 including also a transferring station for transferring the box, in a final, erected configuration and with said first end closed, to a pocket conveyor for filling the box; said conveying means moving the picking up member through said transferring station.

11. A device as claimed in claim 10, wherein said conveying means move the picking up member in an intermittent way, along a defined path, extending between the loading station and the transferring station.

12. A device as claimed in claim 10, including also a marking station for the affixing a code on the box; the marking station being situated between the loading station and the transferring station.

13. A device as claimed in claim 9, including also, at said loading station, a magazine for containing boxes arranged in their initial, flat configuration, and at least one picking up member, which withdraws each box from the magazine and transfers the box in its initial, flat configuration to the picking up member.

14. A device as claimed in claim 13, including also actuating means for moving the picking up member between a loading position, in which the picking up member faces the picking up member.

15. A device as claimed in claim 12, wherein the picking up member is a suction picking up member including at least one suction cup.

16. A device as claimed in claim 9, including two separate of said picking up members, which engage the box at intermediate points of respective walls; the picking up members moving one with respect to the other to give to the box said final, erected configuration.

17. A device as claimed in claim 9, wherein each picking up member is a suction picking up member including at least one suction cup.
